(19) United States
(12) Patent Application Publication
(10) Pub. No.: US 2001/0015133 A1
(43) Pub. Date: Aug. 23, 2001

(54) Gas recovery system and gas recovery method

(75) Inventors: Itsuko Sakai, Yokohama-shi (JP); Junko Ohuchi, Yokohama-shi (JP); Tokuhisa Ohiwa, Kawasaki-shi (JP); Nobuo Hayasaka, Yokosuka-shi (JP); Katsuya Okumura, Yokohama-shi (JP)

Correspondence Address: Finnegan, Henderson, Farabow,, Garrett & Dunner, L. L. P., 1300 I Street, N. W., Washington, DC, 20005-3315, US

(73) Assignee: Kabushiki Kaisha Toshiba

(21) Appl. No.: 09/741,040

(22) Filed: Dec. 21, 2000

(30) Foreign Application Priority Data
Dec. 24, 1999 (JP) 11-368269

(51) Int. Cl. B01D 46/00

(52) U.S. Cl. 95/273; 95/288; 96/372; 55/434.2

(57) ABSTRACT

In a gas recovery system, before gases including PFC are diluted with nitrogen gas, a cooling mechanism trap separates the gases into PFC and the other gases, and the separated PFC is stored temporarily in a temporary storage mechanism until it reaches a concentration at which an efficient recovery of PFC is possible, and thereafter, the temporarily stored PFC is packed in a cylinder.

### CROSS-REFERENCE TO RELATED APPLICATIONS

This application is based upon and claims the benefit of priority from the prior Japanese Patent Application No. 11-368269, filed Dec. 24, 1999, the entire contents of which are incorporated herein by reference.

### BACKGROUND OF THE INVENTION

This invention relates to a gas recovery system and a gas recovery method.

Processes using reactive gases have been widely used in various semiconductor manufacturing techniques, including etching, CVD, surface modification, cleaning, and impurity addition. In addition to use in wafer processes, they have also been used in a wide variety of applications, such as dry cleaning of the process chambers or dry cleaning of the exciting chamber of an excimer laser or the inside of the mirror tube of an electron beam drawing unit.

In those processes, not only highly reactive gases noxious to the human body but also many stable gases considered to be harmless to the human body but contribute to global warming, such as SF₆ or PFC (Per-Fluorocompounds), have been used widely.

Although the production and emission of SF₆ or PFC are smaller than those of CO₂, they have a great effect on global warming, because they have very high global warming coefficients. Thus, the emission of such gas as SF₆ to the atmosphere must be eliminated from the viewpoint of global environment protection.

To remove many noxious gases used in the manufacture of semiconductors, a noxious gas removal unit that removes noxious gas by causing zeolite or active carbon to adsorb the gas has been used. When this type of removal unit is used to remove noxious gas, the concentration of a toxic substance must be decreased below a specific value. Not infrequently, a large amount of diluent pure nitrogen gas is used in order to decrease the concentration of the toxic substance below the specific value, in such a manner that it is thrown away after use.

Furthermore, to recover combustible gas safely, it is necessary to dilute the combustible gas below the flammable limit on the downstream side of the exhaust pump. The diluent pure nitrogen gas is produced by refining nitrogen. The use of a thermal power plant for generating electric power used in generating the pure nitrogen gas is one of the factors that produce CO₂ which is a problem in terms of prevention of global warming.

Various methods of recovering PFC have been proposed. For example, there has been a method of temporarily holding the exhaust gas passed through the noxious gas removal unit in a gas tank, transferring it into a gas cylinder, transporting the gas cylinder to a gas factory, and refining the gas at the factory.

As for in-line recovery techniques, the technique has been proposed which uses a membrane filter with fine holes of the molecular level to separate PFC making use of the difference in size between PFC and the molecule of diluent gas, such as nitrogen gas, and selectively recover the PFC.

The former technique requires the operation of a large-scale gas recovery system and therefore is inefficient unless a large amount of the same gas is used, which makes it difficult to operate such a system in terms of cost. With advances in semiconductor devices, the kind of gas used in semiconductor processes is frequently changed. In fact, a wide variety of gases have been used in semiconductor processes. Therefore, a large amount of the same gas is used less frequently.

FIG. 7 is a schematic block diagram of a conventional gas recovery system for an apparatus that processes a substrate using down flow plasma (a down flow etching apparatus).

In FIG. 7, numeral 81 indicates an etching chamber. In the etching chamber 81, a susceptor is provided. On the susceptor, an Si wafer, a substrate to be processed, is placed. On the Si wafer, a polycrystalline silicon film has been formed. In the etching chamber 81, a plasma of reactive gas is generated. The plasma is used to process the polycrystalline silicon film. A mixed gas of CF₄ and O₂ is widely used as etching gas.

Here, CF₄ gas is one of PFC and its emission will possibly be under regulations in the future. In semiconductor processing techniques, use of gases containing CF (fluorocarbon), including CF₄, C₄F₈, and CHF₃, is indispensable. Thus, it is necessary to make an effort to suppress the emission of such gas in the field of semiconductor manufacturing.

In FIG. 7, numeral 82 indicates an active gas feed pipe. The active gas is supplied via the active gas feed pipe 82 onto the surface of the polycrystalline silicon film in the etching chamber 81.

The active gas is obtained by activating, by such energy as microwaves, the mixed gas whose flow and mixture ratio are controlled. Specifically, the active gas is such highly reactive gas as F, CFX, or O. The active gas reacts with silicon, forming a reaction product with a high vapor pressure, which causes the etching of the polycrystalline silicon film to progress.

As a result, the etching chamber 81 pumps the undecomposed gases in the plasma, the decomposed gases, including F and CF_{X}, the gases generated as a result of the reaction of the decomposed gases, including COF_{X}, C_{X}F_{Y}, and etching product gases, including SiF_{X} (X=1 to 4) and CO₂ generated as a result of reaction with a polycrystalline silicone film.

The gases are pumped out of from the chamber 81 into the exhaust pipe 83 by a dry pump 84, a vacuum exhaust unit and sent to a noxious gas removal unit 85 which removes noxious gas from the gases. Then, the resulting gases pass through the duct in the semiconductor manufacturing plant and a scrubber removes solid material from the gases. The resulting gases are then pumped out to the atmosphere.

In the noxious gas removal unit 85, active, noxious gases COF_{X} or C_{X}F_{Y} or noxious gas CO is removed by such means as adsorption or combustion. Stable CF₄ gas, however, cannot be removed by the removal unit 85, and is pumped out to the atmosphere. This is one of the causes of global warming.

In the conventional recovery method, a membrane filter and a cooling trap are provided just outside the outlet of the scrubber before the last stage, that is, the place where the exhausts from many units in the factory are put together. The membrane filter and cooling trap separate and recover the gases.

In other words, a large amount of purging nitrogen is flowed to the exhaust system, e.g., the dry pump, in order to dilute harmful reaction gases, so that corrosion and degradation of the pump are suppressed. This lowers the PFC concentration, and the collection efficiency degreases below practical limits.

FIG. 8 is a schematic block diagram of a conventional gas recovery system for a vertical type LPCVD apparatus. In FIG. 8, numeral 91 is a process chamber. In the process chamber 91, a susceptor is provided. On the susceptor, an Si wafer, a substrate to be processed, is placed. Into the process chamber 91, 500 sccm of SiH₄ gas and 2 sccm of AsH₃ gas are introduced from the gas feed pipe 92.

The gases are decomposed by the heat from the heater provided in the process chamber 91. The resulting gases reach the surface of the Si wafer, thereby forming an arsenic-added polycrystalline silicon film on the Si wafer.

The process chamber 91 pumps the undecomposed gases, the decomposed gases, and the gases generated as a result of the reaction of the decomposed gases via the exhaust pipe 93 by means of the dry pump 94 provided on the downstream side of the exhaust pipe 93. The pumped out gases from the dry pump 94 and diluent gas N₂ are supplied to a noxious gas removal unit 95 for removing noxious substance from the gases. The resulting gases pass through the duct in the factory and a scrubber removes solid material from the gases. The resulting gases are then pumped out as exhaust gases to the atmosphere.

At this time, since on the downstream side of the dry pump 94, the noxious substance included in the exhaust gas and the concentration of the combustible gas must be kept below specified values, 150 liters of the diluent pure nitrogen gas is supplied from a gas feed pipe 96. The thermal power plant for generating the electric power used in refining nitrogen gas is one of the factors that produce CO₂, which is a problem in terms of prevention of global warming.

### BRIEF SUMMARY OF THE INVENTION

The object of the present invention is to provide a practical gas recovery system and gas recovery method which efficiently recover a specific gas pumped out of a process chamber, suppress the cost of the recovery, and thereby alleviate the load on the environment.

The foregoing object is accomplished by providing a gas recovery system having a gas separation unit which separates gases including a specific gas pumped out of a process chamber into first gas including the specific gas and second gas excluding the specific gas, and temporary storage unit which temporarily stores the specific gas separated by the gas separation unit.

The foregoing object is further accomplished by providing a gas recovery method by separating gases including a specific gas pumped out of a process chamber into the specific gas and the gases excluding the specific gas, temporarily storing the separated specific gas, and discharging the gases excluding the separated specific gas out of the gas recovery system.

Here, the processes carried out in the process chamber are processes using gases including reactive gases, such as etching, film formation, surface modification, impurity addition, or cleaning (removing impurities attached to the surface). The number of process chambers may be one or more.

The gas separation unit includes a cooling trap unit. Specifically, the cooling trap unit includes a first cooling trap placed in an area (a first area) on a halfway part of the exhaust line provided between the process chamber and an exhaust unit, a cooling trap placed in an area (a second area) laid aside from the exhaust line, switching unit which performs switching between the two cooling traps, and regeneration unit which eliminates the trapped gas from the cooling trap placed in the second area and regenerating the cooling trap in the second area, with the cooling trap in the second area being connected to the temporary storage unit.

The temporary storage unit includes a circulation mechanism for circulating the specific gas through a circulation pipe. Specifically, the temporary storage unit includes an exhaust unit which is connected via a pipe to the gas separation unit and pumps the specific gas out of the gas separation unit, a gas compression unit which is connected via a pipe to the downstream side of the exhaust unit and compresses the specific gas, a pipe for connecting the downstream side of the gas compression unit with the upstream side of the exhaust unit, and a valve inserted in a halfway point of the pipe connecting the downstream side of the exhaust unit with the upstream side of the gas compression unit.

With the above configuration, even when the specific gas (for example, PFC gas) pumped out of the exhaust unit has to be diluted with nitrogen gas, the specific gas can be separated before the specific gas has been diluted too much, which makes it possible to recover the specific gas efficiently. As a result, it is possible to realize a practical gas recovery system and gas recovery method which suppress the cost required to recover the specific gas pumped out of the semiconductor manufacturing apparatus and alleviate the load on the environment.

Use of gas not containing oxygen gas or hydrogen gas as gas excluding the specific gas would make safer the handling of gas including the specific gas and facilitate a temporary storage of the specific gas at subsequent stages and further simplify the refining or decomposing of the specific gas.

According to another aspect of the present invention, there is provided a gas recovery system having a diluting unit for adding diluent gas to exhaust gas including a specific gas pumped out of a process chamber, a filter into which a mixed gas of the exhaust gas and the diluent gas is introduced and which pumps the gas including the diluent gas obtained by removing the specific gas from the mixed gas, and a return unit which returns the gas pumped out of the filter to the upstream side of the filter.

According to still another aspect of the present invention, there is provided a gas recovery method having adding diluent gas to exhaust gas including a specific gas pumped out from a process chamber to generate a mixed gas of the exhaust gas and the diluent gas, removing the specific gas from the mixed gas and thereby selecting the gases including the diluent gas from the mixed gas, and recycling the selected gases including the diluent gas as diluent gas for diluting the exhaust gas.

With this configuration, because the diluent gas used in diluting the specific gas (for example, noxious gas, such as arsine gas or combustible gas, such as disilane gas (SiH₂) or silane gas (SiH₄) can be recycled, the amount of diluent gas used can be reduced. As a result, the cost of diluent gas can be lowered. Moreover, the power consumed in generating the diluent gas can be decreased. In this way, the load to the power plant including the thermal power plant can be decreased and the amount of CO₂ generated can be decreased.

Consequently, with the present invention, it is possible to realize a practical gas recovery system and gas recovery method which reduce the cost required to operate the semiconductor manufacturing apparatus and alleviate the load on the environment.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic block diagram of a gas recovery system for a down flow etching apparatus according to a first embodiment of the present invention;

FIGS. 2A to 2E are illustrations to explain the effect of the gas recovery system in the first embodiment;

FIG. 3 is a block diagram of a modification of the gas recovery system in the first embodiment;

FIG. 4 is a schematic block diagram of a gas recovery system for a vertical type LPCVD apparatus according to a second embodiment of the present invention;

FIG. 5 is a schematic block diagram of a gas recovery system for an RIE etching apparatus according to a third embodiment of the present invention;

FIG. 6 is a schematic block diagram of a gas recovery system for a down flow etching apparatus according to a fourth embodiment of the present invention;

FIG. 7 is a schematic block diagram of a conventional gas recovery system for a down flow etching apparatus; and

FIG. 8 is a schematic block diagram of a conventional gas recovery system for a vertical type LPCVD apparatus.

### DETAILED DESCRIPTION OF THE INVENTION

First, the problems of the in-line recovery technique using a conventional membrane filter detected by the inventors of the present invention will be explained. Since the recovery technique uses a membrane filter, it is necessary to keep the pressure of the gas supplied to the membrane filter at a constant value or higher. In addition, there are many restrictions on the concentration of PFC gas with respect to diluent gas. In a plant where a great deal of processing is done by turning on and off gas at each production unit repeatedly, the supply of exhaust gas is very unstable. For this reason, it is almost impossible to use the technique by the in-line method (the method of putting together the exhaust lines of many units and supplying the gas directly to a separation unit).

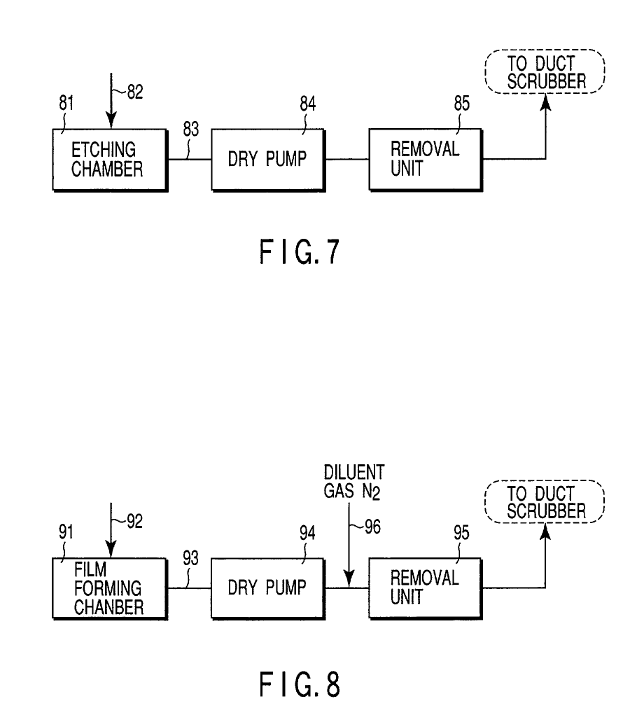

The conventional gas recovery system of FIG. 7 uses a method of separating and recovering the gas by means of a membrane filter and a cooling trap, as described earlier. With this method, however, a change in the operating state of the units changes the load on the recovery system frequently, which lowers the recovery efficiency substantially.

To dilute noxious reactive gas, a large amount of purging nitrogen is caused to flow in the exhaust system of each unit. This dilutes the concentration of the gas to be recovered, for example, CF₄ gas in the gas supplied to the recovery system to less than 0.2%.

For example, it is assumed that a unit using CF₄ gas of several hundred sccm is operated at almost its full capacity. In this case, the amount of CF₄ gas to be recovered in a day is about 500 liters. When that amount of gas is compressed to 9.78 MPa, it can be packed in a single 10-liter cylinder. However, what actually is recovered is CF₄ diluted by a large amount of nitrogen. That is, to recover 500 liters of CF₄, 250000 liters of nitrogen-diluted-CF₄ gas must be collected

Not only is such dilute gas difficult to compress, but also it is very inefficient to operate the compressor continuously to compress the dilute gas. Thus, the compression of dilute gas does not pay well, which makes it difficult to operate the recovery system in terms of cost.

(First Embodiment)

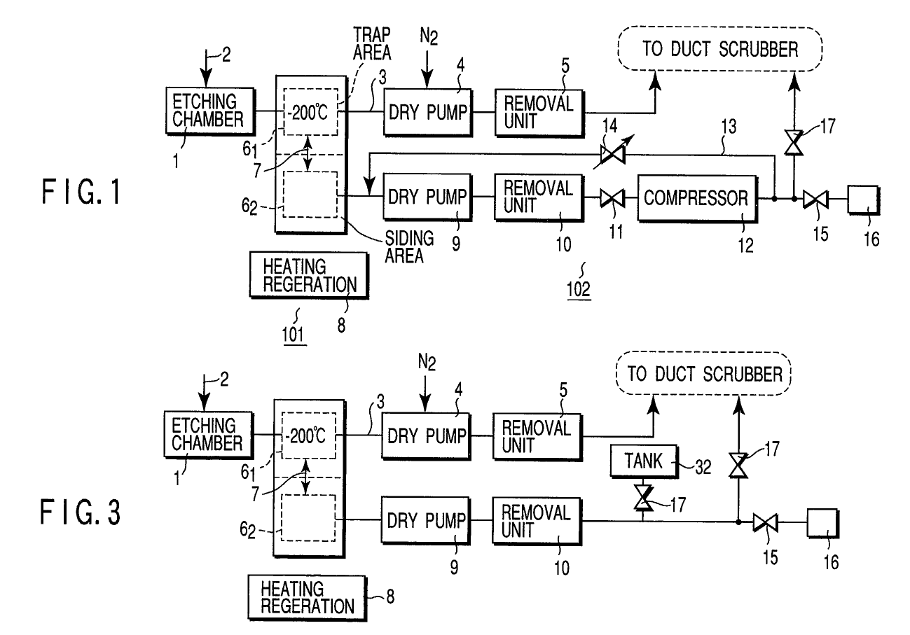

FIG. 1 is a schematic block diagram of a gas recovery system for a down flow etching apparatus according to a first embodiment of the present invention. This gas recovery system corresponds to the conventional one shown in FIG. 7.

In FIG. 1, reference numeral 1 indicates an etching chamber, 2 a gas feed pipe, 3 a gas exhaust pipe, 4 a dry pump, and 5 a noxious gas removal unit. These units 1 to 5 and a duct, a scrubber, and others on the downstream side of them are the same as those in the conventional gas recovery system of FIG. 7.

The present embodiment is characterized in that a cooling trap mechanism 101 is provided between the etching chamber 1 and the dry pump 4 and that a temporary storage mechanism 102 is provided on the downstream side of the cooling trap mechanism 101.

The cooling trap mechanism 101 includes a first cooling trap 6₁ placed in a trap area on a halfway part of the gas exhaust pipe 3, a second cooling trap 6₂ laid aside in a siding area from the gas exhaust pipe 3, and a switching mechanism 7 for switching between the cooling traps 6₁, 6₂.

Since the temperature of the first cooling trap 6₁ placed in the trap area is kept at −200° C., the gases whose vapor pressure is low, such as PFC gas, in the exhaust gas from the etching chamber 1 become liquid or solid, which is adsorbed by the first cooling trap 6₁, whereas the gases whose vapor pressure is high, such as oxygen, is not adsorbed by the first cooling trap 6₁. Diluent N₂ gas has been supplied to the dry pump 4. The N₂ gas, too, is not adsorbed by the first cooling trap 6₁.

When either the first cooling trap 6₁ or the second cooling trap 6₂ gets saturated, the saturated cooling trap 6₁ or 6₂ is switched to the other unsaturated cooling trap 6₁ or 6₂.

One cooling trap 6₁ or 6₂ separated from the gas exhaust pipe 3 is regenerated by heating the cooling trap 6₁ or 6₂ with a heating regeneration mechanism 8 to cause the captured gas to leave the trap.

The adsorption of more than a certain amount of gas to the cooling traps 6₁ and 6₂ lowers the cooling efficiency, leading to a decrease in the adsorption efficiency. In the first embodiment, to avoid this problem, the cooling traps 6₁ and 6₂ have been designed to have a large enough capacity to adsorb gas from one lot at a time. That is, the capacity of the cooling traps 6₁ and 6₂ has been designed so as to adsorb the maximum amount of gas adsorbable in each lot at a time.

Switching is done between the cooling traps 6₁ and 6₂ according to the amount of adsorbent gas with suitable timing between the lot processes, thereby carrying out the heating regeneration of the cooling traps 6₁ and 6₂.

At least one of the cooling traps 6₁ and 6₂ can be regenerated simultaneously with the etching process in the etching chamber 1. That is, during the etching process, the exhaust gas is trapped by the other cooling trap (6₁ or 6₂) placed in the gas exhaust pipe 3. To prevent the regenerating process from restricting the speed of the etching process, the heating regeneration mechanism 8 is designed to make the time required for heating regeneration shorter than the total time of the wafer transfer time and the shortest processing time of one lot.

The temporary storage mechanism 102 is connected to the cooling trap 6₁ or 6₂ laid aside in the siding area. The temporary storage mechanism 102 is composed of a dry pump 9, a noxious gas removal unit 10, a valve 11, a compressor 12, a circulation line 13 connecting the downstream side of the compressor 12 to the upstream side of the dry pump 9, and a variable valve 14 inserted halfway down the circulation line 13.

The downstream side of the compressor 12 and circulation line 13 branches into a pipe connected to a detachable joint 16 for packing the compressed gas via an isolation valve 15 into a gas container, such as a cylinder, and a pipe connected via an isolation valve 17 to a duct scrubber.

The gas generated at the cooling trap 61 or 62 in regenerating the adsorbed gas is pumped out by the dry pump 9 and detoxified by the noxious gas removal unit 10. Then, the detoxified gas circulates through the circulation line 13, with the isolation valves 15, 17 closed. As long as the isolation valves 15, 17 are kept closed, the pumped out gas is accumulated inside the circulation line 13. The gas, however, does not stay because it is circulated by the dry pump 9.

Placing the cooling trap mechanism 101 halfway down the gas exhaust pipe enables such gas as PFC gas chemically stable and having a high global warming coefficient to be trapped before the gas is diluted too much, even when the gas pumped out by the dry pump 4 has to be diluted with nitrogen gas. This makes it possible to recover the PFC gas and the like efficiently.

Furthermore, when the cooling trap 6₁ or 6₂ in the trap area is set at a temperature at which oxygen gas and hydrogen gas whose vapor pressure is high are not adsorbed, these gases can be removed from the exhaust gas and recovered. This makes not only the handling of the recovered gas safer but also the subsequent refining process (and further recycling process) or decomposing process simpler and easier.

The gases including PFC gas pumped out in the diluted state are accumulated, while being circulated through the circulation line. When the gas has reached a certain amount, that is, when it has reached a concentration at which economically efficient recovery is possible, the compressor 12 is started, the valves 11, 14 are closed, and at the same time, the valve 15 is opened, the gas compressed by the compressor 12 is packed via the joint 16 into a cylinder. This makes possible the economically efficient recovery of such gas as PFC gas.

The recovered gases packed in the cylinder or the like are conveyed by transportation means, such as a track, to facilities in the plant. In the facilities, the gases are processed intensively. Alternatively, the gases are transported to a gas plant, which refines the gases and then recycle them. Depending on the situation, the decomposing and detoxifying processes may be effected by a combustion method, plasma decomposition method, chemical adsorption method, catalytic method, or the like.

As described above, before the exhaust gas is mixed with diluent nitrogen gas, the cooling trap mechanism 101 selectively adsorbs the desired gases contained in the exhaust gas, removes the gas components preventing recovery and refinement, and recovers the resulting gases, thereby processing PFC gas and the like efficiently.

That is, because the unwanted gas components (one of gas noxious to the human body, gas noxious to the environment, and combustible gas, e.g. one of Per-Fluorocompounds gas, arsine gas, disilane gas, diborane gas, phosphine gas and silane gas.) are removed from the recovered gases and the resulting gases are compressed, the compressed gases are conveyed at lower transportation cost efficiently to post-processing facilities. Moreover, since the content of components other than PFC gas and the like to be refined and recycled is low, refinement can be performed efficiently. An increase in the efficiency of the decomposing process can also be expected as in refinement and recycling.

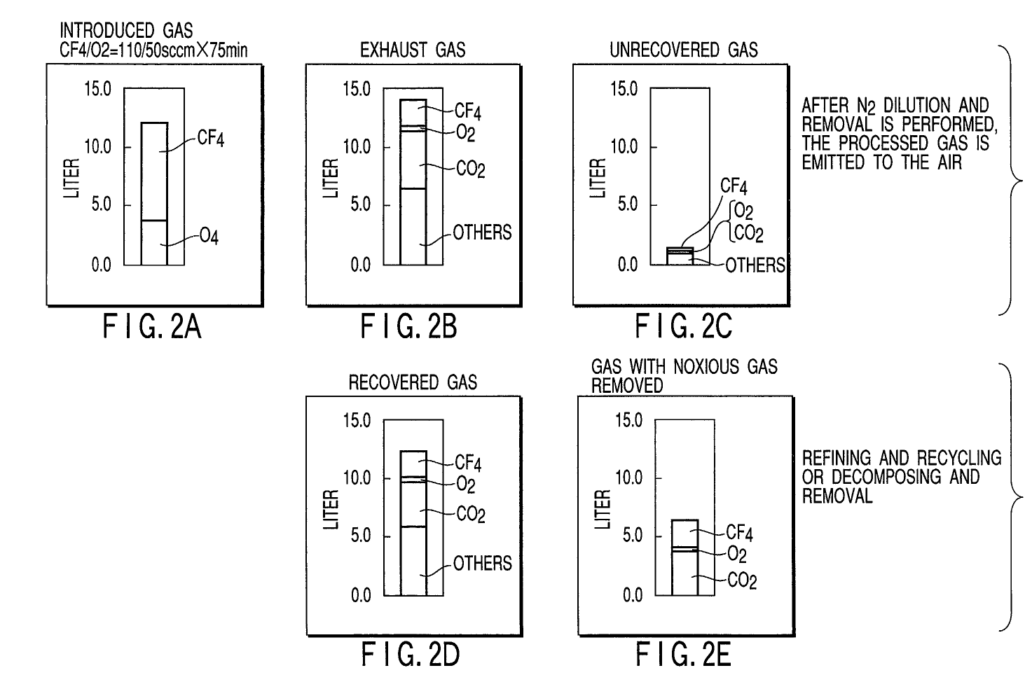

To examine how much the gas recovery system of the first embodiment traps gases, the exhaust gas was sampled and the molecular composition of the gases was analyzed. The etching conditions for a polycrystalline silicon film were as follows: the flow rates of CF₄ and O₂ to the etching chamber 1 were 110 sccm and 50 sccm, respectively, and the microwave power was 700 W. In one lot process, gas was introduced and discharging was done for a total of 75 minutes. The results of examining the pumped out gas are shown in FIGS. 2A to 2E. FIGS. 2A to 2E have shown the following things.

The gases pumped out of the etching chamber 1 are CF₄, O₂, CO₂, and other gases (including SiF₄, COF₂, CO, and HFF₂). The proportion of, for example, CF₄ gas sensed in front of the cooling trap 6₁ or 6₂ to the introduced gas is about 30% of the amount of the introduced gas. This shows that about 70% of the gases were consumed in etching or gas-phase reaction. The global warming coefficient of CF₄ is much higher than that of CO₂ (6400 times higher than that of the latter). Therefore, it is necessary to eliminate the emission of CF₄ from the viewpoint of protection of global environment. Since CF₄ is less burnable, it can be recycled.

On the other hand, it is understood that, after the gases have passed through the cooling trap 6₂ or 6₁ of −200° C., the other gases are all removed and only the gases whose vapor pressure is high, including CO, F₂, and O₂, pass through the cooling trap.

Thus, this offers the merit of being able to decrease the flow rate of diluent gas caused to flow through the dry pump 4. Since highly reactive noxious components, including SiF₄, COF₂, and F₂, were removed by the noxious gas removal unit 5 on the more downstream side, the gases finally pumped out to the atmosphere were only the gases with low environmental loads, including CO₂ and O₂.

On the other hand, the gases regenerated from the cooling trap, detoxified by the noxious gas removal unit 10, and accumulated in the circulation line 13 were mainly CO₂ and CF₄, with the amount of gases processed in one lot being about 7 liters. After the gases were accumulated in the circulation line 13 for 10 lots, the gases accumulated according to the aforementioned recovery procedure were compressed to 0.88 MPa and packed in a 10-liter cylinder. At this time, because the line capacity between the compressor 12 and the gas coupling means 16 was a dead space which could not be filled with the gases, the line capacity was made as small as possible.

With the embodiment, PFC can be selected from the exhaust gas made up of many kinds of dilute components, concentrated, compressed, and recovered, which makes it possible to refine and recycle the PFC efficiently. At this time, because the oxygen concentration of the recovered gas has decreased considerably as compared with the introduced gas, the safety of handling and the gas refining efficiency in refinement and recycling are improved remarkably.

Specifically, with the gas recovery system, processing is done using such gases as PFC and SF₆ effective in processing substrates but having a high environmental load, and the recycling of those gases is realized safely and efficiently without discharging those gases to the atmosphere at all. Therefore, it is possible to provide a gas processing system which decreases the purchase amount of new gas, improving the productivity and imposing a less load on the environment.

FIG. 3 shows a modification of the first embodiment. The system of FIG. 1 is of the type where CO₂ and others are accumulated temporarily in the circulation line 13. As shown in FIG. 3, CO₂ and others may be accumulated in a buffer tank 32. In FIG. 3, numeral 31 indicates a valve, which is left open when temporary accumulation is effected.

(Second Embodiment)

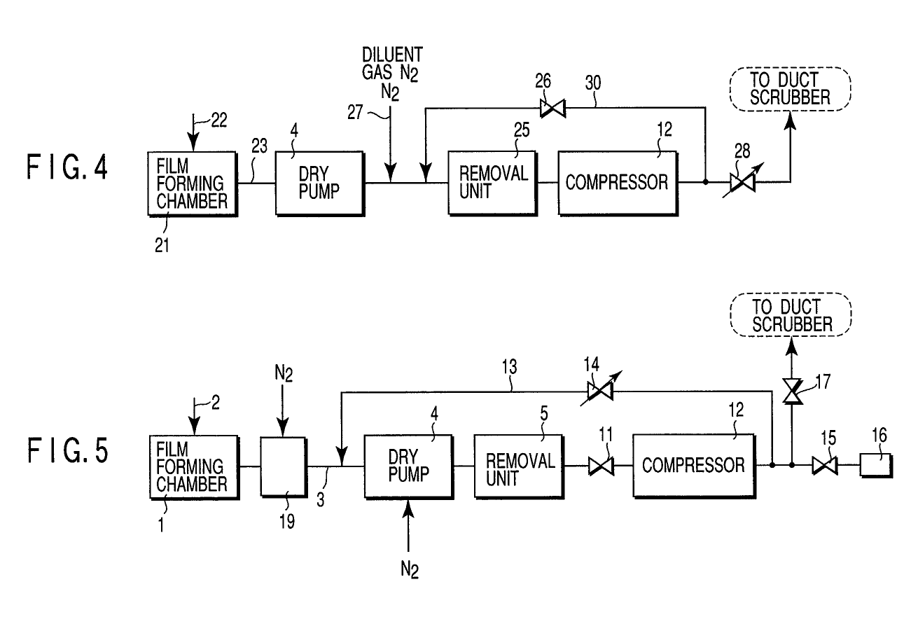

FIG. 4 is a schematic block diagram of a gas recovery system for a vertical type LPCVD apparatus according to a second embodiment of the present invention. A case where a polycrystalline silicon film is formed with the vertical type LPCVD apparatus will be explained.

In FIG. 4, numeral 21 indicates a film forming chamber, 22 a gas feed pipe, 23 a gas exhaust pipe, 24 a dry pump, and 25 a noxious gas removal unit. These units 21 to 25 and a duct, a scrubber, and others on the downstream side of them are the same as those in the conventional gas recovery system of FIG. 8. In FIG. 4, numeral 29 indicates a compressor, and 30 a circulation pipe. The compressor 29 and circulation pipe 30 correspond to the compressor 12 and circulation pipe 13 in FIG. 1.

On the susceptor in the film forming chamber 21, an Si wafer, a substrate to be processed, is placed. Into the film forming chamber 21, 500 sccm of SiH₄ gas and 2 sccm of AsH₃ gas are introduced from the gas feed pipe 22.

The gases are decomposed by the heat from the heater provided in the film forming chamber 21. The resulting gases reach the surface of the Si wafer, thereby forming an arsenic-added polycrystalline silicon film on the Si wafer. At this time, the undecomposed SiH₄ and AsH₃ and hydrogen gas pass through the gas exhaust pipe 23 and are pumped out by the dry pump provided on the downstream side of the gas exhaust pipe 23. On the downstream side of the dry pump 24, to remove noxious substance and combustible gases from the exhaust gas with the noxious gas removal unit 25, it is necessary to mix the exhaust gas with diluent gas to lower the concentration of the noxious substance and combustible gases below a specified value.

To do this, the valve 26 is closed before the introduction of process gas, and diluent pure nitrogen gas is introduced at a rate of 150 liters/minute from a gas introduce line 27 on the downstream side of the dry pump 24.

Thereafter, the valve 26 is opened and a variable valve 28 is throttled down, thereby not only permitting 80% of the exhaust gas to circulate through the circulation line 30 but also reducing the flow rate of introduced diluent gas to 30 liters/minute.

In this way, even when the amount of introduced diluent gas is decreased by the recycling of the diluent gas, the concentration of the noxious substance and combustible gas in the pipe between the dry pump 24 and noxious gas removing device 25 can be suppressed below the specified value in introducing the process gas. As a result, the power contributing to the generation of CO₂ used to refine the diluent gas is reduced, which helps prevent global warming. For example, in this case, the power of 14.4 Kw can be saved. Furthermore, the amount of diluent gas used can be decreased by the recycling of the diluent gas, which helps lower the cost of diluent gas. When the amount of N₂ gas used in the plant can be decreased to 20% according to the present invention, the power for refining the diluent gas can be reduced, thereby achieving the cost down of 100,000 yen per apparatus per one month.

Consequently, it is possible to decrease not only the cost for recovering the specific gas pumped out of the film forming chamber 21 but also the environmental load.

While in the second embodiment, only one vertical type LPCVD apparatus has been used, more than one vertical type LPCVD apparatus may be used. In this case, more than one film forming changer 21 is connected to the single dry pump 24.

(Third Embodiment)

FIG. 5 is a schematic block diagram of a gas recovery system for an RIE etching apparatus according to a third embodiment of the present invention. In FIG. 5, the same parts as those in FIG. 1 are indicated by the same numerals and their detailed explanation will be omitted.

The gas recovery system of the third embodiment makes an efficient recovery of gases whose global warming coefficient is high and which has a large environmental load and is particularly suitable for a process in which a large amount of diluent gas is not used on the downstream side of the dry pump.

Although the gas recovery system of the first embodiment has been provided with a cooling trap mechanism, the gas recovery system of the third embodiment is not provided with a cooling trap mechanism.

The gas recovery system of the third embodiment is for recovering the exhaust gas generated in cleaning the etching chamber 1 of an RIE etching unit that processes a substrate using plasma.

When a substrate in the etching chamber 1 is processed, more specifically, when a polycrystalline silicon film is etched, highly noxious, corrosive etching gas, such as HBr or Cl₂, is used. For this reason, diluent pure nitrogen gas is supplied to a turbo molecule pump 19 and dry pump 4 that exhaust the etching chamber 1, thereby etching the polycrystalline silicon film while diluting the exhaust gas.

At this time, with the valves 14, 15 being kept closed, the noxious components in the gases pumped out via the exhaust pipe 3 are removed by the noxious gas removal unit 5. The exhaust gas eventually pass through the isolation valve 17 and is pumped out to the duct scrubber. The proportion of the global warming substances included in the gases pumped out of the duct scrubber is relatively small.

On the other hand, in the cleaning process (plasma cleaning) of the etching chamber 1 carried out each time one lot of Si wafers is processed, SF₆ gas whose global warming coefficient is very large has been used. SF₆ gas is so stable that an ordinary noxious-gas removal unit cannot remove the gas. Until now, the SF₆ gas has been pumped out to the atmosphere.

In the third embodiment, a control system for separating the gas used to process the Si wafer and the gas used for cleaning is introduced. When the etching chamber 1 is cleaned, the supply of the diluent nitrogen gas to the turbo molecule pump 19 and dry pump 4 is stopped, 3 slm of SF₆ gas is introduced into the etching chamber 1, and the pressure is controlled to 500 mTorr. Thereafter, a high frequency power of 300 W is applied, thereby generating plasma and cleaning the etching chamber 1.

At this time, with the valves 15, 17 closed, the valve 14 is regulated and the exhaust gas is caused to circulate in the exhaust pipe 13. The exhaust gas contains a large amount of unreacted SF₆ gas, HF gas decomposed and generated by plasma, and SiF₄ gas caused by the reaction of gas cleaning (etching). Of these gases, the noxious HF gas and SiF₄ gas are removed by the noxious gas removal unit 5, whereas the SF₆ gas remains unchanged in the circulation pipe 13.

After ten minutes' cleaning has ended, the valves 11, 14 are closed, the valve 15 is opened, the gases mainly containing SF₆ gas are compressed by the compressor 12, and the compressed gas is packed in a cylinder via the joint 16. The recovered gas packed in the cylinder is processed in the facilities in the plant. Alternatively, the gases are transported to a gas plant, which refines the gases and then recycle them. Depending on the situation, the gases may be decomposed and detoxified.

As described above, with the third embodiment, addition of a simple pipe configuration makes it possible to recover SF₆ gas efficiently, which was difficult to recover until now.

While in the third embodiment, the number of RIE etching unit is one, more than one RIE etching unit may be used. In this case, a plurality of etching chambers 1 and turbo molecule pumps 19 are to be connected to the gas exhaust pipe 3.

(Fourth Embodiment)

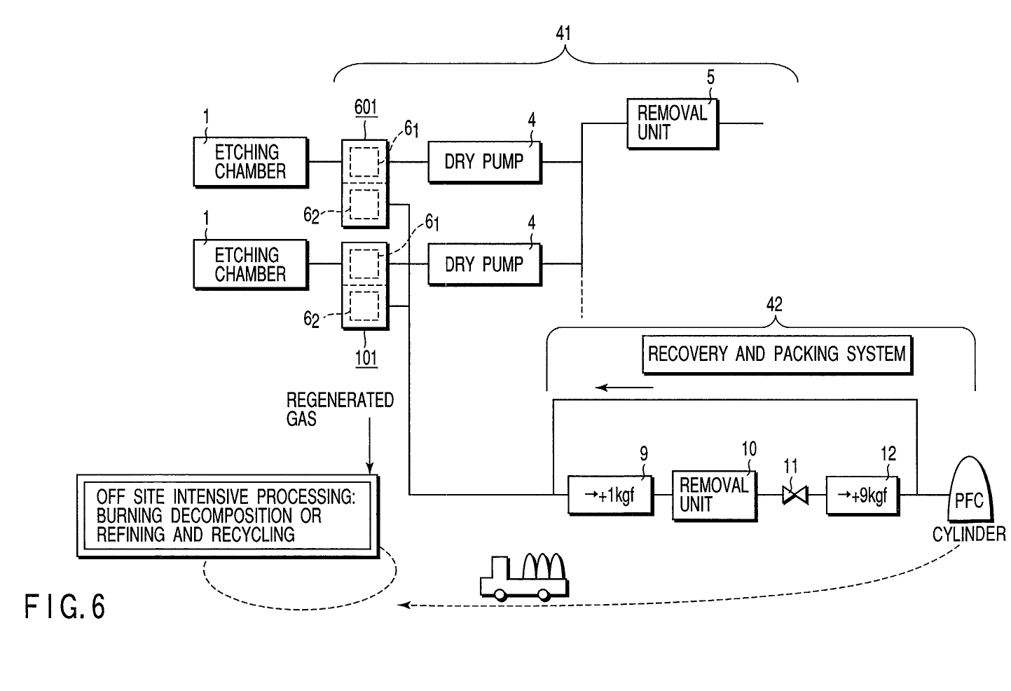

FIG. 6 is a schematic block diagram of a gas recovery system for a down flow etching apparatus according to a fourth embodiment of the present invention. In FIG. 6, the same parts as those in FIG. 1 are indicated by the same numerals and their detailed explanation will be omitted.

In the fourth embodiment, a gas recovery system 41 (with no temporary storage mechanism) similar to that of the first embodiment of FIG. 1 is provided in each down flow etching unit (etching chamber 1) and the gas from each cooling trap mechanism 101 is stored temporarily in a single temporary storage mechanism 42. The temporary storage mechanism 42 is the same as that in the first embodiment.

In the fourth embodiment, because the gases selected by the cooling trap mechanisms 101 provided in the corresponding etching chambers 1 are put together and stored temporarily in the single temporary storage mechanism 42, the gases reach a concentration, in a shorter time, at which efficient recovery is possible.

Consequently, the plant as a whole can not only recover such gases as PFC and SF₆ effectively but also reduce the cost of recovering the gases including PFC and SF₆ effectively. Moreover, the recovery environmental preservation system is improved.

In general, when a cooling trap mechanism is used, gas does not always flow at a constant rate, but flows intensively at the time of heating and regeneration. For this reason, to temporarily store the gases efficiently using the cooling trap mechanism, it is desirable to operate the compressor in synchronization with the timing of heating and regeneration. Such control is usually difficult. Thus, use of more than one gas recovery system would make such control much more difficult.

With the fourth embodiment, since the temporary storage mechanism is provided separately from the cooling trap mechanism, the above-described control is not necessary and use of more than one gas recovery system is not a problem.

While in the fourth embodiment, the temporary storage mechanism has been shared, the cooling trap mechanism may be shared instead.

The present invention is not limited to the above embodiments. For instance, while the embodiments have been explained using the down flow etching apparatus and thermal CVD apparatus, the present invention may be applied to techniques using reactive gases, in addition to wafer processes, as long as a system to which a gas circulation system is connected is constructed. The techniques include RIE, plasma CVD, surface modification, cleaning, impurity addition, semiconductor manufacturing technology on the whole, including dry cleaning of the process chamber, and dry cleaning of the exciting chamber of an excimer laser or the inside of the tube of an electron beam drawing unit. Moreover, the present invention may be practiced or embodied in still other ways without departing from the spirit or essential character thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gas recovery system comprising:
a gas separation unit which separates gases including a specific gas pumped out of a process chamber into said specific gas and the gases excluding said specific gas;
a temporary storage unit which temporarily stores said specific gas separated by the gas separation unit; and
an exhaust unit which pumps the gases excluding said specific gas separated by said gas separation unit out of said gas recovery system.

2. The gas recovery system according to claim 1, wherein said specific gas is one of gas noxious to the human body, gas noxious to the environment, and combustible gas.

3. The gas recovery system according to claim 1, wherein said specific gas is one of Per-Fluorocompounds gas, arsine gas, disilane gas, diborane gas, phosphine gas and silane gas.

4. The gas recovery system according to claim 1, wherein said gases excluding said specific gas are either oxygen gas or hydrogen gas.

5. The gas recovery system according to claim 1, wherein said gas separation unit includes a cooling trap unit.

6. The gas recovery system according to claim 5, wherein said cooling trap unit includes a first cooling trap placed in a first area on a halfway down the exhaust line provided between the process chamber and an exhaust unit, a second cooling trap placed in a second area laid aside from said exhaust line, a switching unit which performs switching between said first and second cooling traps, and a regeneration unit for eliminating the trapped gas from said second cooling trap placed in the second area and regenerating said second cooling trap, with the cooling trap in the second area being connected to the temporary storage unit.

7. The gas recovery system according to claim 1, wherein said temporary storage unit includes a circulation mechanism for circulating the specific gas through a circulation line.

8. The gas recovery system according to claim 7, wherein said temporary storage unit includes an exhaust unit which is connected via a pipe to said gas separation unit and pumps the specific gas out of the gas separation unit, a gas compression unit which is connected via a pipe to the downstream side of the exhaust unit and compresses the specific gas, a pipe for connecting the downstream side of the gas compression unit with the upstream side of the exhaust unit, and a valve inserted in a halfway point of the pipe connecting the downstream side of the exhaust unit with the upstream side of the gas compression unit.

9. The gas recovery system according to claim 1, wherein said temporary storage unit includes a temporary tank for storing said specific gas.

10. A gas recovery system comprising:
a diluting unit which adds diluent gas to exhaust gas including a specific gas pumped out of a process chamber;
a filter into which a mixed gas of said exhaust gas and said diluent gas is introduced and which pumps the gas including said diluent gas obtained by removing said specific gas from the mixed gas; and
a return unit for returning the gas pumped out of the filter to the upstream side of said filter.

11. A gas recovery system for gases including a specific gas pumped out of a plurality of process chambers, wherein
a gas recovery system according to claim 1 is provided in each of the process chambers,
temporary storage units or gas separation units in the gas recovery systems are put together into a single unit, which is shared by said plurality of gas recovery systems.

12. The gas recovery system according to claim 1, further comprising a gas transporter which transports the gases including said specific gas temporarily stored in said temporary storage unit and refining unit which refines transported gases transported by said gas transporter including said specific gas and recycling or decomposing them.

13. A gas recovery method comprising:
separating gases including a specific gas pumped out of a process chamber into said specific gas and the gases excluding said specific gas;
temporarily storing said separated specific gas; and
discharging the gases excluding said separated specific gas out of said recovery system.

14. A gas recovery method comprising:
adding diluent gas to exhaust gas including a specific gas pumped out of a process chamber to generate a mixed gas of said exhaust gas and said diluent gas;
removing said specific gas from said mixed gas and thereby selecting the gases including said diluent gas from said mixed gas; and
recycling the selected gases including the diluent gas as diluent gas for diluting said exhaust gas.
